(19) United States
(12) Patent Application Publication
(10) Pub. No.: US 2011/0238431 A1
(43) Pub. Date: Sep. 29, 2011

(54) Surgical Console Information Management

(76) Inventors: Robert Cionni, Salt Lake City, UT (US); Mikhail Boukhny, Laguna Niguel, CA (US)

(21) Appl. No.: 12/729,809

(22) Filed: Mar. 23, 2010

(51) Int. Cl. G06Q 50/00; G06Q 10/00

(52) U.S. Cl. 705/2

(57) ABSTRACT

In various embodiments, completing a pre-surgery checklist may include receiving surgery related information from one or more sources, transferring the received information to a surgical console, presenting the transferred information to a console user as part of the pre-surgery check-list, and receiving indication of a verified information element provided for the pre-surgery check-list (e.g., confirmation from a surgeon that one or more elements on the pre-surgery checklist are correct/verified). In some embodiments, the method may further include verifying a surgical patient's identity prior to surgery.

### FIELD OF THE INVENTION

The present invention generally pertains to consoles. More particularly, but not by way of limitation, the present invention pertains to surgical consoles.

### DESCRIPTION OF THE RELATED ART

The human eye may provide vision by transmitting light through a clear outer portion called the cornea, and focusing the image by way of the lens onto the retina. The quality of the focused image may depend on many factors including the size and shape of the eye, and the transparency of the cornea and lens.

When age or disease causes the lens to become less transparent, vision may deteriorate because of the diminished light which can be transmitted to the retina. This deficiency in the lens of the eye may be referred to as a cataract. One treatment for this condition is surgical removal of the lens and replacement of the lens function by an intraocular lens (IOL).

Cataractous lenses may be removed by a surgical technique called phacoemulsification. During this procedure, a thin phacoemulsification cutting tip may be inserted into the diseased lens and vibrated ultrasonically. The vibrating cutting tip may liquefy or emulsify the lens so that the lens may be aspirated out of the eye. The diseased lens, once removed, may be replaced by an artificial lens (such as an IOL).

### SUMMARY

In various embodiments, completing a pre-surgery checklist may include receiving surgery related information from one or more sources, transferring the received information to a surgical console, presenting the transferred information to a console user as part of the pre-surgery check-list, and receiving indication of a verified information element provided for the pre-surgery check-list (e.g., confirmation from a surgeon that one or more elements on the pre-surgery checklist are correct/verified). In some embodiments, the method may further include verifying a surgical patient's identity prior to surgery.

In some embodiments, receiving surgery related information from one or more sources may include receiving information from a source local or remote to the surgical console. Transferring the received information to a surgical console may include transferring the received information over wired or wireless network. Presenting the transferred information to a console user as part of a pre-surgery check-list may include presenting a checklist and corresponding information elements for the console user's review (e.g., by presenting information through a console screen or a heads-up display unit coupled to a microscope). Receiving indication of a verified information element provided for the pre-surgery check-list may include receiving an input from the console user that an information element has been verified (e.g., completing a check-box or giving a verbal verification).

### BRIEF DESCRIPTION OF THE DRAWINGS

For a more complete understanding of the present invention, reference is made to the following description taken in conjunction with the accompanying drawings in which:

FIG. 1 illustrates a surgical console, according to an embodiment;

FIG. 2 illustrates a flowchart of a method for receiving and verifying patient and surgical information, according to an embodiment;

FIG. 3 illustrates an information screen, according to an embodiment;

FIG. 4 illustrates a pre-surgery checklist, according to an embodiment;

FIGS. 5-6 illustrate a heads-up display and microscope for displaying the information, according to an embodiment; and

FIG. 7 illustrates a processor and memory, according to an embodiment.

It is to be understood that both the foregoing general description and the following detailed description are exemplary and explanatory only and are intended to provide a further explanation of the present invention as claimed.

### DETAILED DESCRIPTION OF THE EMBODIMENTS

### Incorporation by Reference

U.S. Patent Application Publication entitled “System and Method For A User Interface,” Publication No. 20090048587, Ser. No. 11/838,973, by Paul Avanzino, Raphael Gordon, Dan Teodorescu and Ahmad Salehi filed Aug. 15, 2007 is hereby incorporated by reference in its entirety as though fully and completely set forth herein.

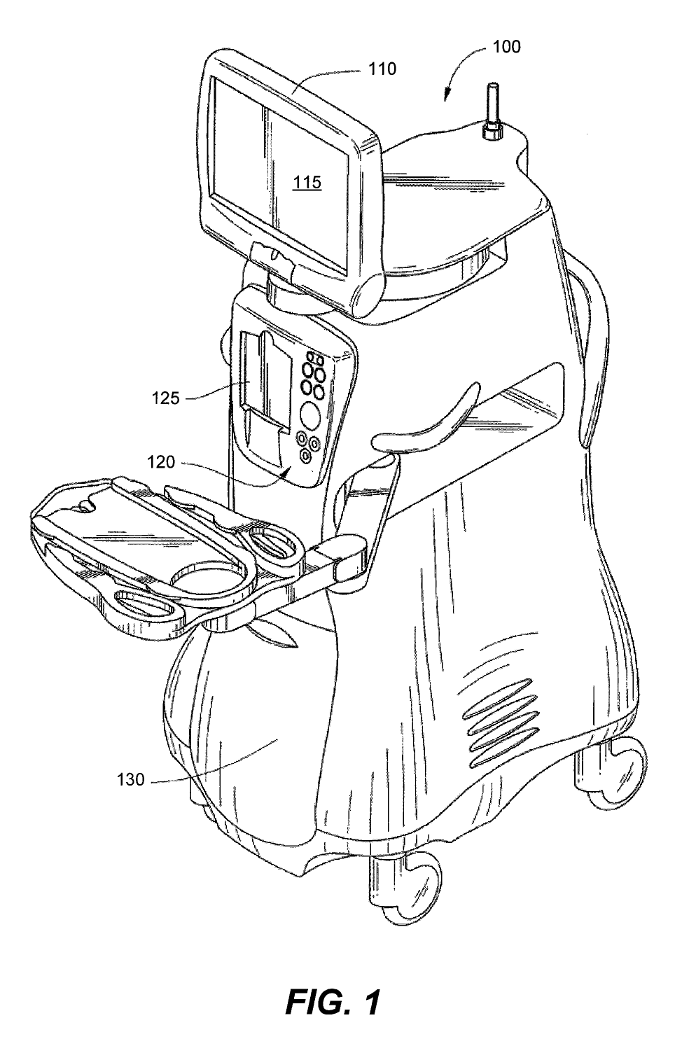

FIG. 1 illustrates an embodiment of an ophthalmic surgical console 100. Surgical console 100 may include a swivel monitor 110 that has touch screen 115. Swivel monitor 110 may be positioned in a variety of orientations for whomever needs to see touch screen 115. Swivel monitor 110 may swing from side to side, as well as rotate and tilt. Touch screen 115 may provide a GUI (Graphical User Interface) that allows a user to interact with console 100. Surgical console 100 may also include a connection panel 120 used to connect various tools and consumables to surgical console 100. Connection panel 120 can include, for example, a coagulation connector, balanced salt solution receiver, connectors for various hand pieces and a fluid management system (“FMS”) or cassette receiver 125. Surgical console 100 can also include a variety of user friendly features, such as a foot pedal control (e.g., stored behind panel 130) and other features. In some embodiments, surgical console 100 may include functionality for vitreous cutting (Vit), vacuum (Extraction), Scissors, Viscous Fluid Control (VFC), ultrasonic lens removal (Fragmatome) and user feedback. Surgical console 100 is provided by way of example and other embodiments may include use of other surgical systems.

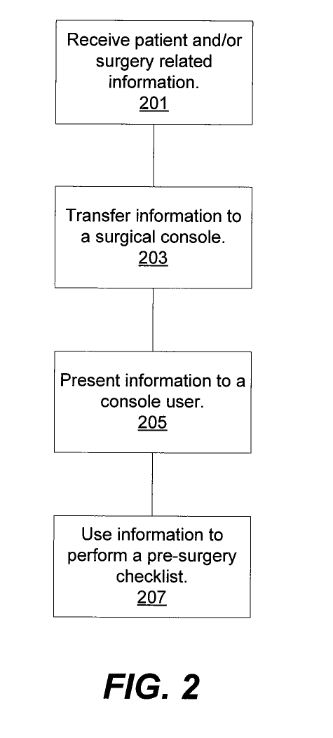

FIG. 2 illustrates a flowchart of an embodiment of a method for receiving and verifying patient and surgical information. The elements provided in the flowchart are illustrative only. Various provided elements may be omitted, additional elements may be added, and/or various elements may be performed in a different order than provided below.

At 201, patient and/or surgery related information may be received by various information collection systems. In some embodiments, information may be received at the surgical console 100 (e.g., entered through the touch screen 115 or a keyboard) or at a location remote from the surgical console 100. For example, information may be collected by medical staff (e.g., a nurse, physician's assistant, surgeon, etc.) at a front desk of a surgeon's office or in an admissions office of a hospital. The information may be collected by medical staff using, for example, a tablet computer, PDA (Personal

Digital Assistant) (or other data collection device) during an initial examination of the patient. In some embodiments, information (e.g., surgical parameters, type of surgical tool to use, personal notes, etc.) may be entered by medical staff (e.g., by a surgeon). For example, the surgeon may enter surgical parameters to use in the surgery in the surgeon's office computer (which may be connected to a central computer that is also connected to the surgical console 100). In some embodiments, information may be entered by a patient (e.g., through a website displayed on the patient's home computer). In some embodiments, the information may be entered at multiple sites (e.g., part of the information may be entered by the patient on the website (e.g., prior to being admitted) and part of the information may be entered by a nurse in the surgeon's office).

In some embodiments, the information may include a patient's full name, address, age, gender, current health problems (such as diabetes, glaucoma, heart disease, high blood pressure, hearing problems, etc.), current health conditions (e.g., body temperature, heart rate, blood pressure, various blood counts, whether the eyes have recently been dilated, etc.), information from the patient's medical chart, emergency contact information, insurance information, and other information that may be relevant to a surgical procedure (e.g., information needed to complete a pre-surgery check-list). Information may also include direct information about the surgical procedure itself For example, which eye is to be operated on, the type of procedure (cataract removal, vitrectomy, etc.), special patient information (e.g., patient is especially nervous about the procedure, patient requested additional information about the procedure prior to starting, etc.), and patient identification information. Patient identification information may include a picture of the patient, information about physical features of the patient (e.g., patient hair color, eye color, height, weight, etc.), and security related information (e.g., patient retina scan, fingerprint, voice print, etc). Other information may also be included.

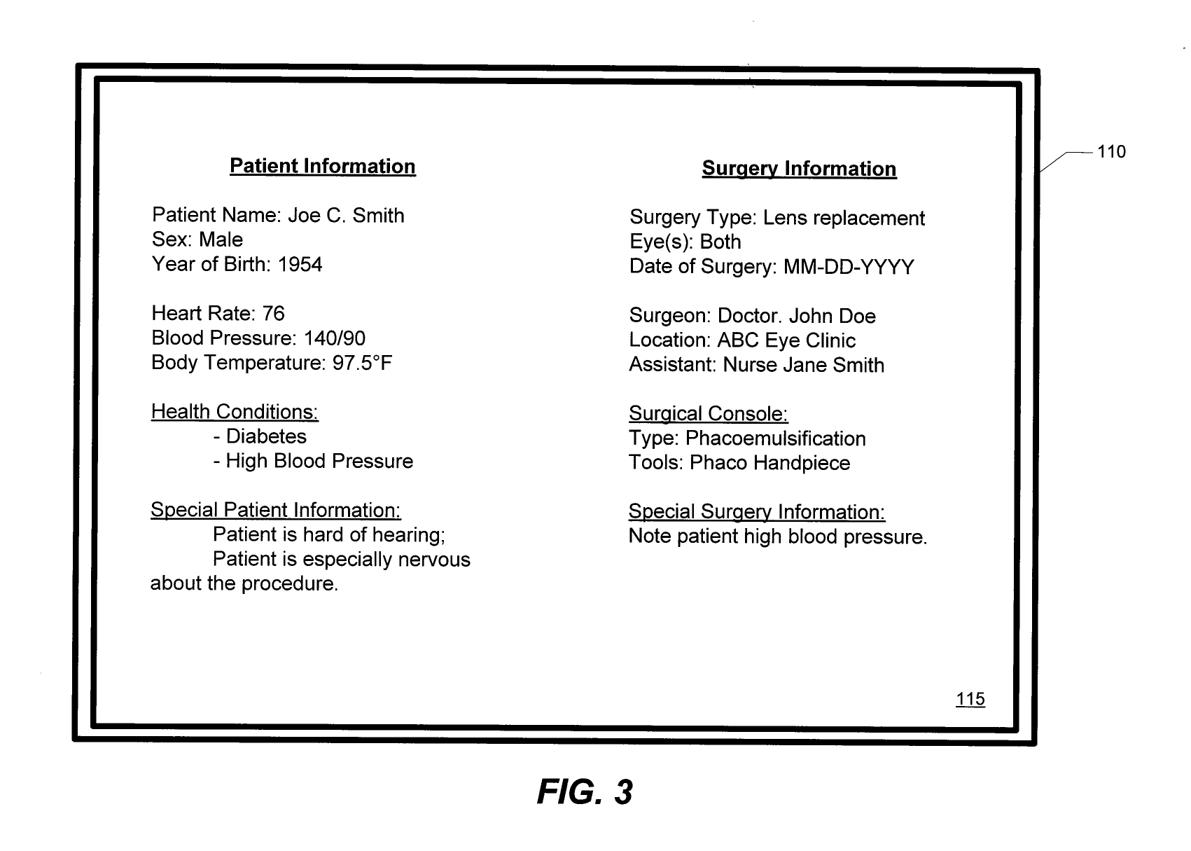

At 203, information may be transferred to the surgical console 100. Information may be transferred to the console 100 through a wired or wireless interface. For example, information may be collected from various sources at a central computer and the central computer may transmit a portion or all of the information to the surgical console 100 through a wireless link (such as through a wireless router or an Ethernet cable). In some embodiments, information may be resident on the console 100 (e.g., information may be entered directly into the console 100 through the touch screen 115 or a keyboard). FIG. 3 illustrates an example of information displayed on monitor 110 of the console 100.

At 205, information may be presented by the surgical console 100 to a console user (e.g., a nurse, physician's assistant, surgeon, etc). For example, the information may be displayed on the monitor 110 or provided over speakers (e.g., which may be internal to the console 100). Other ways of presenting the information are also contemplated.

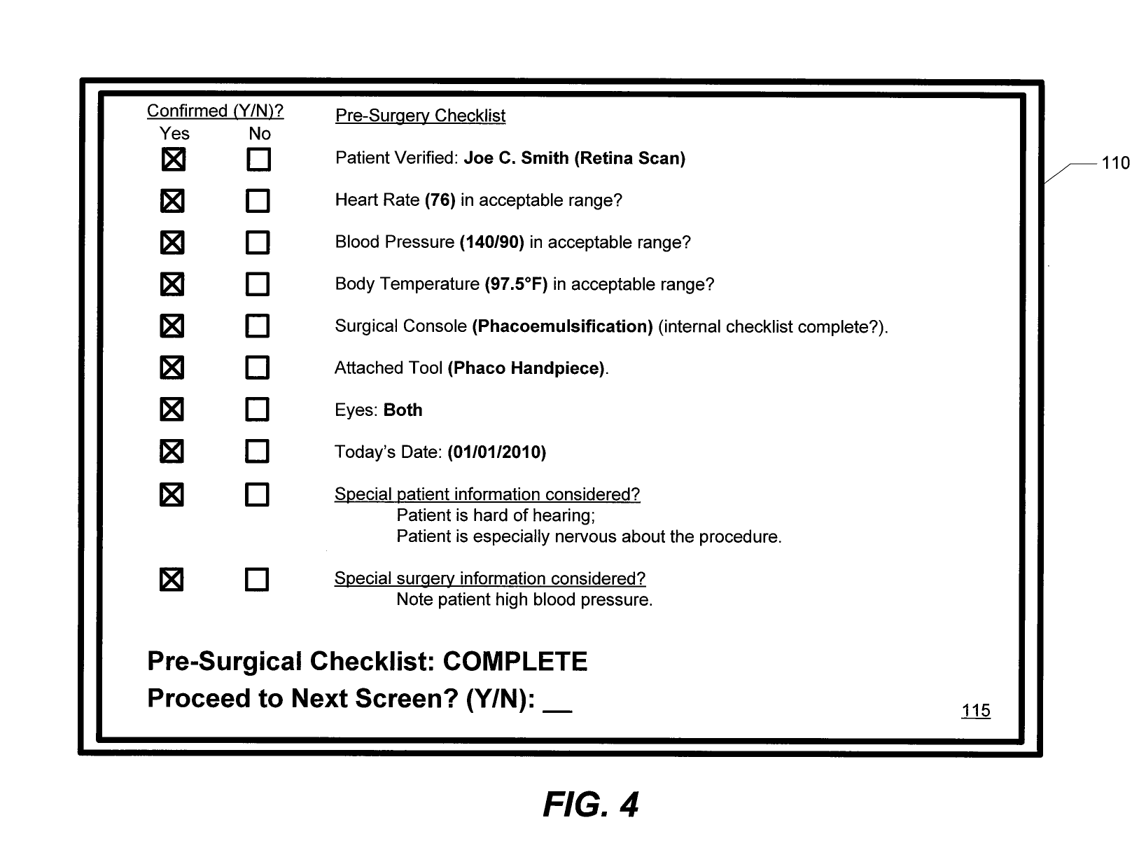

At 207, information may be used by the medical staff to perform a pre-surgery checklist. As seen in FIG. 4, a pre-surgery checklist may include verifying informational elements such as the patient's name, date of surgery, patient's vital signs (such as heart rate, blood pressure, etc.), type of surgery, involved eye, etc. In some embodiments, the pre-surgery checklist may also include verifying the patient's identity. The checklist may be completed by a medical staff member selecting a yes/no box (or in some other way confirming/rejecting) for each component of the check-list. In some embodiments, the console may complete one or more of the checklist items. For example, the console may run internal diagnostics and check an appropriate box (or in some other way indicate a result). Other information may also be presented. For example, specific surgical parameters (e.g., default parameters or parameters set by the surgeon in advance) may be relayed to the medical staff (e.g., by being displayed on touch screen 115 or read aloud through a console speaker). In some embodiments, the console may require completion of the check-list prior to the start of a surgical procedure.

In some embodiments, prior to surgery, a patient fingerprint, retina scan, iris scan, voice print, etc., may be taken to compare to a previously acquired sample to verify the patient's identity. In some embodiments, the patient may touch a fingerprint scanner or have his/her retina scanned by the console which may then check an appropriate box on the checklist (or in some other way indicate a result of the check). Upon verifying the patient's identity, the surgeon may have additional confidence that the surgical information associated with the patient in the console 100 is correct. In some embodiments, the patient verification may prevent accidentally performing the wrong procedure on a patient (e.g., a patient that was prepared for surgery and wheeled into the wrong room).

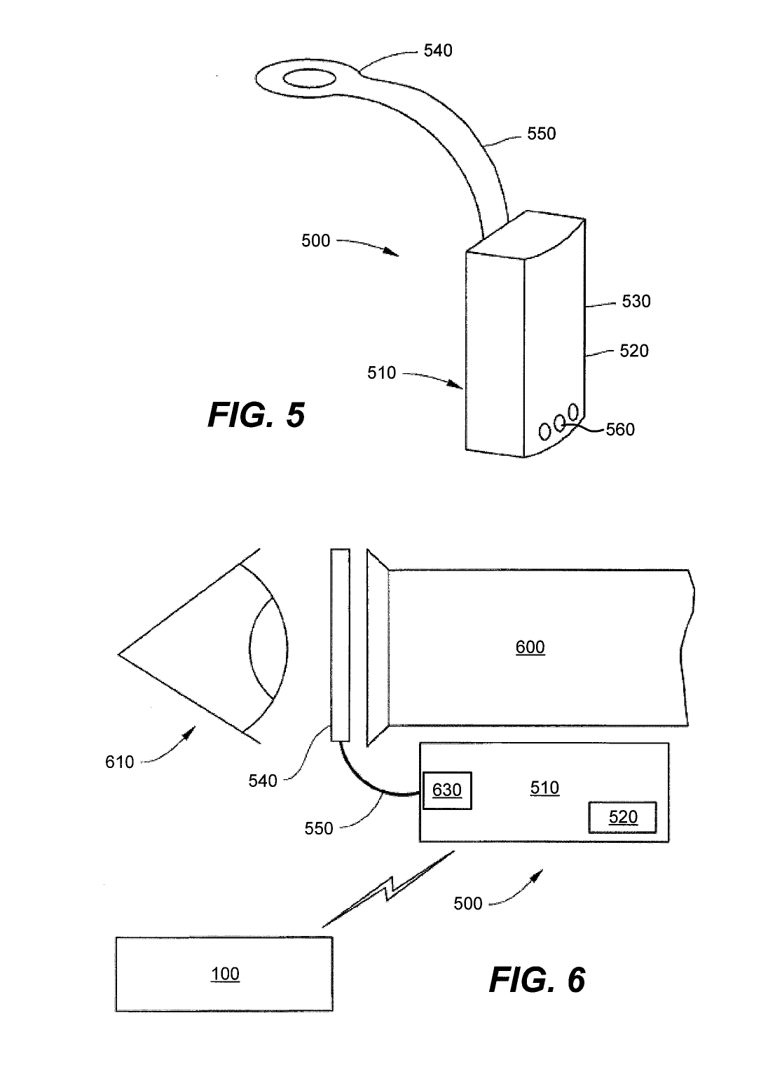

In some embodiments, the information and check-lists may be presented in a heads-up display (e.g., as seen in FIG. 5) for use with a microscope (e.g., for use in a surgical procedure). Heads-up display unit 500 may include body 510 which may be configured to mount to a microscope (e.g., used in performing surgical procedures) or another ophthalmologic instrument. Body 510 may, in turn, include a wired and/or wireless transceiver 520 to communicate with, for example, surgical console 100 (or another source of data). The body 510 may further include a speaker 530 to produce audio output and/or a set of indicator LED (light emitting diode) lights 560, or another light source, operable to produce at least a portion, if not substantially the whole spectrum of, visible light and which may further be operable to produce a variety of light patterns (e.g. blink rates of a single color, alternating patterns of colors, blink rates of multiple colors, etc.). Heads-up display unit 500 may also include eye-piece ring 540 which may be made from a translucent rubber or polymer operable to conduct light. Eye-piece ring 540 may be coupled to body 510 of heads-up display 500 by flexible guide 550 which may be made of translucent rubber, polymer, plastic film, or a light pipe such that light produced by the set of indicator LED lights 560 may be conducted to eye-piece ring 540. Light guide 550 may also be shielded or otherwise surrounded to block out interference from ambient light. Eye-piece 540 ring may be configured to be fitted into, onto, or be the eye-piece of a microscope with which heads-up display 500 is being utilized such that light produced by the set of LED indicator lights and conducted by guide 550 may be presented in the eye-piece of the microscope through eye-piece ring 540.

FIG. 6 illustrates a representation of the use of heads-up display 500 during a surgical procedure. During a surgical procedure, information (e.g., for a checklist and/or relative to configured surgical parameters) may be transmitted from surgical console 100 to transceiver 520 on heads-up display 500. Heads-up display 500 may provide a visual and/or audio indication of the information. Visual feedback produced by heads-up display 500 (e.g. by set of LED lights 630) may be conducted throughout guide 550 to eye-ring 540 fitted on microscope eye-piece 600 such that user 610 may be presented with this visual feedback without having to look away from microscope eye-piece 600 or the surgical procedure he is conducting.

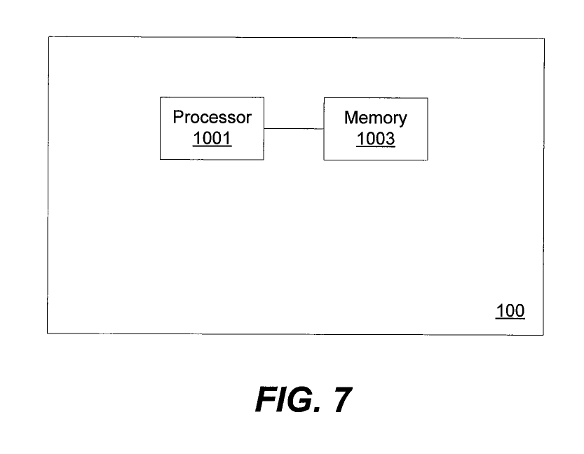

As seen in FIG. 7, in some embodiments, the information collection systems and surgical console may include one or more processors (e.g., processor 1001). The processor 1001 may include single processing devices or a plurality of processing devices. Such a processing device may be a microprocessor, controller (which may be a micro-controller), digital signal processor, microcomputer, central processing unit, field programmable gate array, programmable logic device, state machine, logic circuitry, control circuitry, analog circuitry, digital circuitry, and/or any device that manipulates signals (analog and/or digital) based on operational instructions. The memory 1003 coupled to and/or embedded in the processors 1001 may be a single memory device or a plurality of memory devices. Such a memory device may be a read-only memory, random access memory, volatile memory, non-volatile memory, static memory, dynamic memory, flash memory, cache memory, and/or any device that stores digital information. Note that when the processors 1001 implement one or more of its functions via a state machine, analog circuitry, digital circuitry, and/or logic circuitry, the memory 1003 storing the corresponding operational instructions may be embedded within, or external to, the circuitry comprising the state machine, analog circuitry, digital circuitry, and/or logic circuitry. The memory 1003 may store, and the processor 1001 may execute, operational instructions corresponding to at least some of the elements illustrated and described in association with the figures.

Various modifications may be made to the presented embodiments by a person of ordinary skill in the art. Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A method, comprising:
receiving surgery related information from one or more sources;
transferring at least a portion of the received information to a surgical console;
presenting at least a portion of the transferred information to a console user as part of a pre-surgery check-list; and
receiving indication of a verified information element provided for the pre-surgery check-list.

2. The method of claim 1, wherein receiving surgery related information from one or more sources comprises receiving information from a source remote to the surgical console.

3. The method of claim 1, wherein transferring at least a portion of the received information to a surgical console comprises transferring at least a portion of the received information over wireless network.

4. The method of claim 1, wherein presenting at least a portion of the transferred information to a console user as part of a pre-surgery check-list comprises presenting a checklist and corresponding information elements for the console user's review.

5. The method of claim 4, wherein receiving indication of a verified information element provided for the pre-surgery check-list comprises receiving an input from the console user that an information element has been verified.

6. The method of claim 1, wherein presenting at least a portion of the transferred information to a console user as part of a pre-surgery check-list comprises presenting information through a heads-up display unit coupled to a microscope.

7. The method of claim 1, further comprising verifying a surgical patient's identity.
